(19) United States
(12) Patent Application Publication
(10) Pub. No.: US 2026/0349273 A1
(43) Pub. Date: Nov. 5, 2026

(54) HINGE ASSEMBLY FOR GLASSES AND GLASSES COMPRISING SUCH A HINGE ASSEMBLY

(71) Applicant: LUXOTTICA S.R.L., Agordo (BL) (IT)

(72) Inventor: Moreno DAL PONT, Belluno (BL) (IT)

(73) Assignee: LUXOTTICA S.R.L., Agordo (BL) (IT)

(21) Appl. No.: 19/126,414

(22) PCT Filed: Nov. 10, 2023
(86) PCT No.: PCT/IB2023/061379

§ 371 Date: May 1, 2025

(30) Foreign Application Priority Data
Nov. 18, 2022 (IT) 102022000023850

(51) Int. Cl. G02C 5/22

(52) U.S. Cl. CPC G02C 5/2254

(57) ABSTRACT

A hinge assembly for glasses that includes a support plate having a first cantilevered portion and a second cantilevered portion, a support body rotatably coupled to the support plate, at least one guide element, a guide end of the support body sliding on the at least one guide element in order to guide the reciprocal rotation of the support body and the support plate between a first stable opening position of the hinge assembly for glasses and a third unstable extra-opening position of the hinge assembly for glasses, a first guide projection and a second guide projection made on the respective cantilevered portion, at least one free abutment wall of the support body shaped to slide on the first and second guide projections to guide the reciprocal rotation of the support body and the support plate between the first stable opening position and a second stable closing position.

The present invention relates to a hinge assembly for glasses particularly but not exclusively usable in “smart” glasses.

The present invention also relates to glasses comprising such a hinge assembly.

Though such a hinge assembly can be used in all the types of glasses, for ease of discussion, for exemplary and non-limiting purposes, focus will be made only on “smart” glasses.

As known, “smart” glasses, also referred to as intelligent glasses or virtual glasses or digital glasses, mean a pair of glasses comprising electronic devices adapted to operate as a computer capable of providing support to the activities performed by the user wearing them, both in daily and private field and in working and business field or in any other particular field.

Currently used “smart” glasses allow to display on the lenses needed information and/or objects or to use vocal commands to interact with the glasses themselves, such as to save time and financial cost in many operations, and further give the user the possibility to work in a safer manner having both his/her hands free.

In more detail, the “smart” glasses available on the market nowadays consist of electronic devices and of software capable of playing videos, audios, filming, operating computer applications, recognizing the natural language, the shapes and the objects arranged in the surrounding environment.

The “smart” glasses are provided with a displaying device, such as for example a display, typically integrated in the lenses of the frame for glasses or arranged thereon, and an electronic processing and control unit, such as for example a controller or a battery, usually integrated in the frame for glasses or in the temples thereof.

As known, “smart” glasses provided with a bistable hinge are present on the market.

The bistability of the hinge allows to keep the temple of the frame for glasses stationary and stable in the operating position in which it is, or opening or closing, preventing it from moving accidentally and without the user's will, causing discomfort to the latter.

For example, document DE102020210683B3 describes a bistable hinge of a frame for glasses formed by a first joint region configured to connect the hinge to the front of the frame for glasses and identify a first joint axis, and by a second joint region configured to connect the hinge to the rod of the frame for glasses and identify a second joint axis, and having a recess, perpendicular to the first and the second joint axes, that acts as a guide to accommodate a cable that connects the front to the rod of the frame for glasses.

Hinges which allow to reach a further flexible extra-opening operating position, referred to as “extra-flex” operating position, in which the angle formed between the temple and the front of the frame for glasses is higher than 90 degrees when the temples are open, are also known.

The “extra-flex” operating position allows an easier wearing operation by the user just due to the flexible extra-opening of the temples, and a greater comfort when the user wears such glasses.

Hinges which provide to reach the “extra-flex” operating position will be referred to as flexible below.

As known, the reaching of the extra-opening position occurs continuing the rotation of the temple after the latter reaches the opening position.

In other words, the extra-opening position is achieved due to a further rotation of the temple, from the opening position, in a direction opposite to a rotation that would allow the temple itself to return in the closing position.

During the passage to the extra-opening position the temple can assume incorrect positions which can result in mechanical stresses on the hinge itself, causing the deterioration and/or breaking thereof.

Furthermore, generally, when the temple rotates to reach the extra-opening position, the end portion of the temple contacts the front of the frame for glasses with the risk, in the long run, to wear out and scrape the front itself.

An object of the present invention is to overcome the above-mentioned drawbacks and particularly to ideate a hinge assembly for glasses, which is bistable and simultaneously “extra-flex” which allows to preserve the integrity of the hinge itself during the passage of the temple from the opening position to the extra-opening position or vice versa.

Another object of the present invention consists in ideating a bistable and simultaneously “extra-flex” hinge assembly which allows to prevent the wear of the temple and the front.

These and other objects according to the present invention are achieved by making a hinge assembly for glasses as set forth in claim 1 and glasses comprising such a hinge assembly as set forth in claim 12.

Further features of the hinge assembly for glasses are the object of the dependent claims.

The features and advantages of a hinge assembly for glasses and glasses comprising such a hinge assembly according to the present invention will be more apparent from the following exemplary and non-limiting description referred to the attached schematic drawings in which:

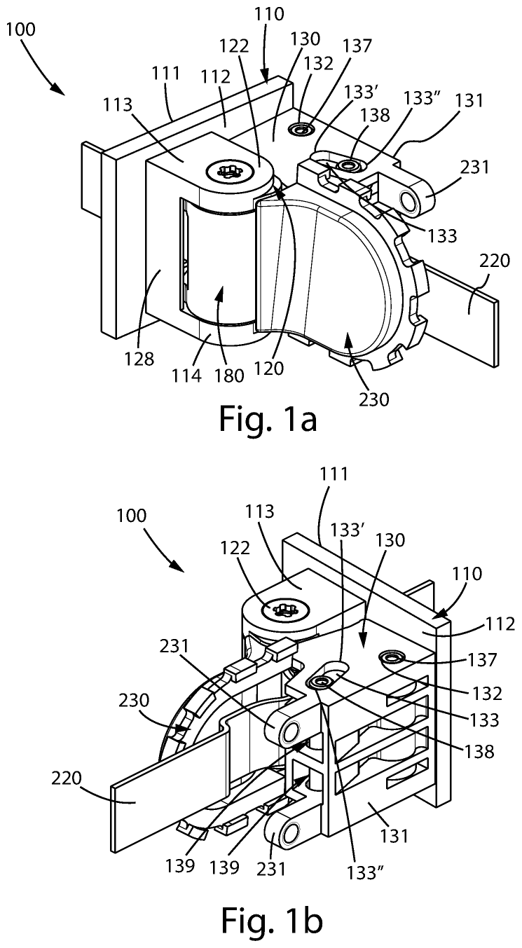

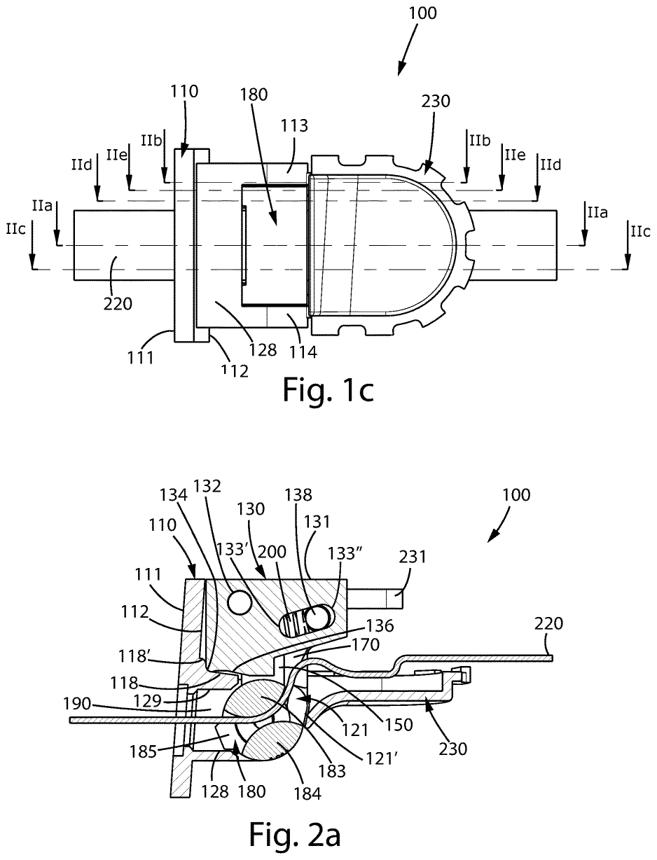

FIG. 1a is a first perspective view of a hinge assembly for glasses according to a first embodiment of the present invention when it is in a first stable opening position;

FIG. 1b is a second perspective view of the hinge assembly for glasses of figure la;

FIG. 1c is a first frontal view, taken from the space interposed between the temple and the front of the glasses, of the hinge assembly for glasses of FIG. 1a;

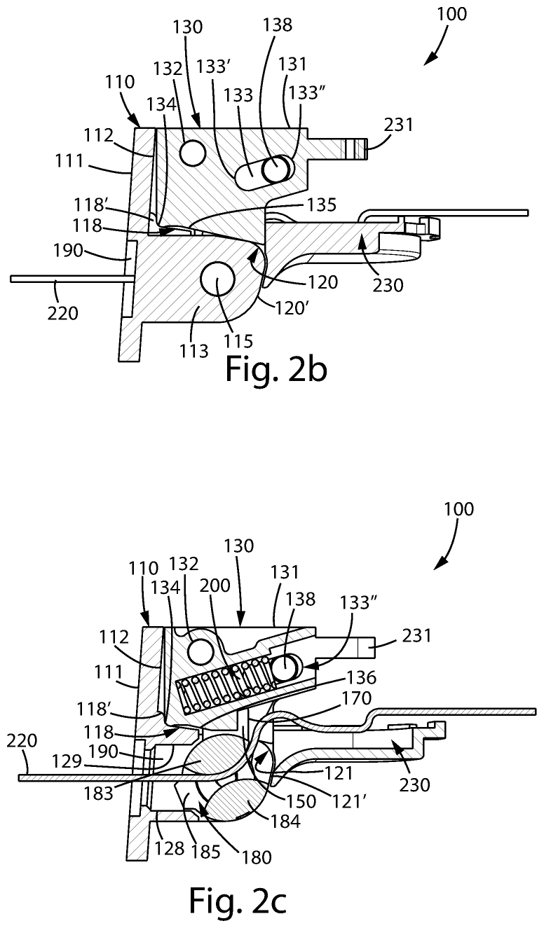

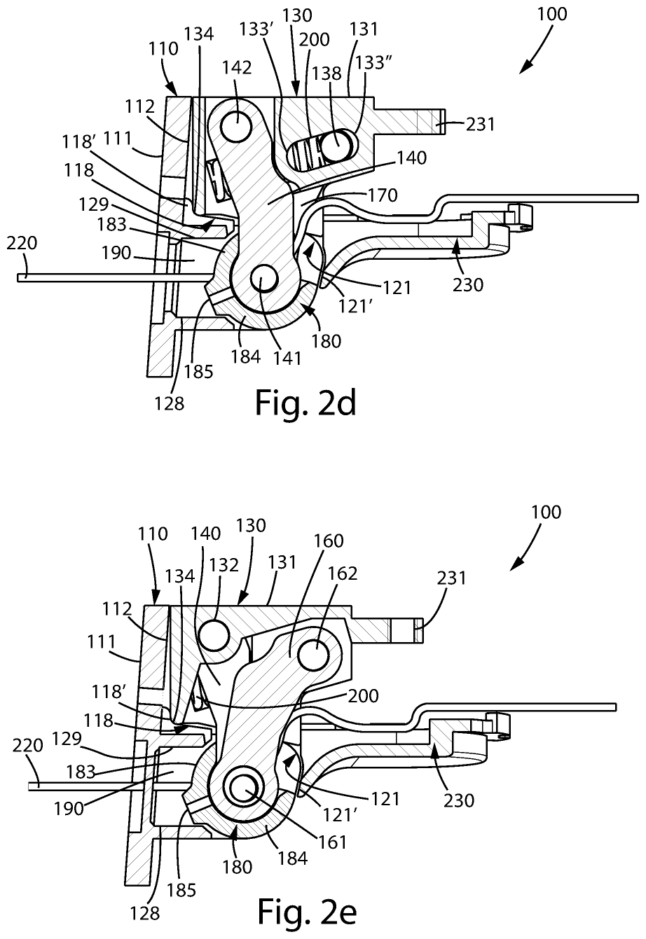

FIGS. 2a, 2b, 2c, 2d, 2e are five sectional views respectively along lines IIa-IIa, IIb-IIb, IIc-IIc, IId-IId, IIe-IIe of the hinge assembly for glasses of FIG. 1c;

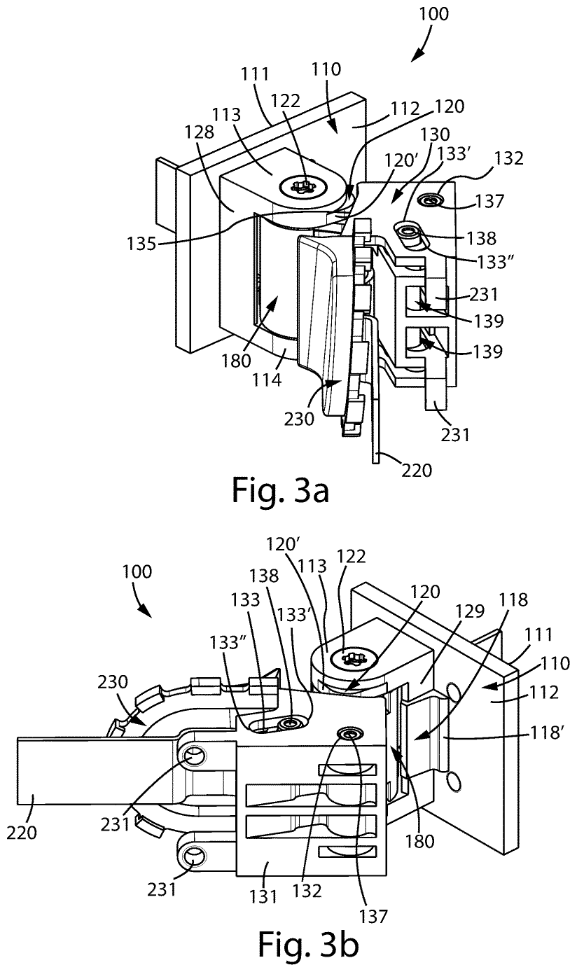

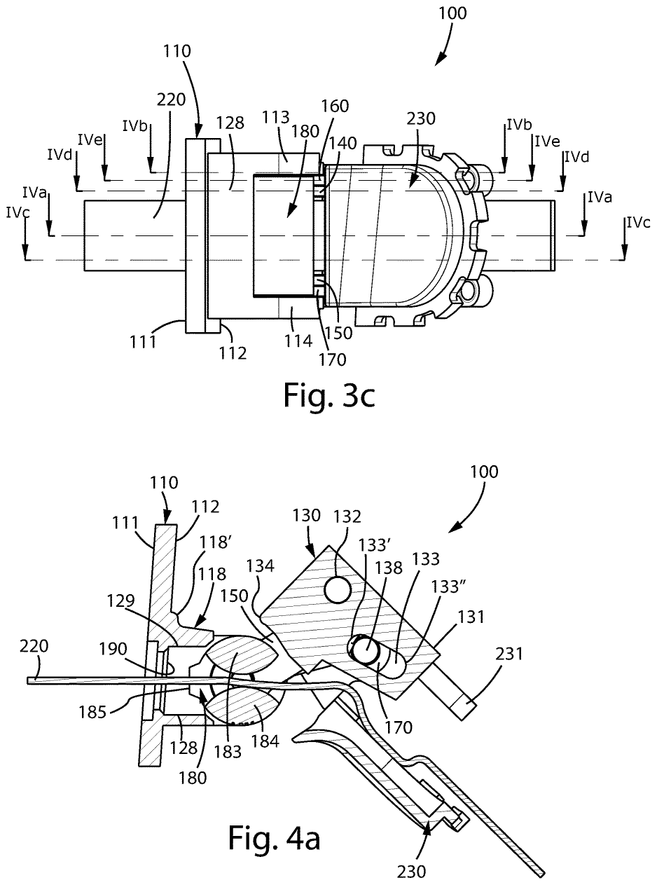

FIG. 3a is a third perspective view of the hinge assembly for glasses according to the first embodiment of the present invention when it is in an intermediate position between the first stable opening position and a second stable closing position;

FIG. 3b is a fourth perspective view of the hinge assembly for glasses of FIG. 3a;

FIG. 3c is a second frontal view, taken from the space interposed between the temple and the front, of the hinge assembly for glasses of FIG. 3a;

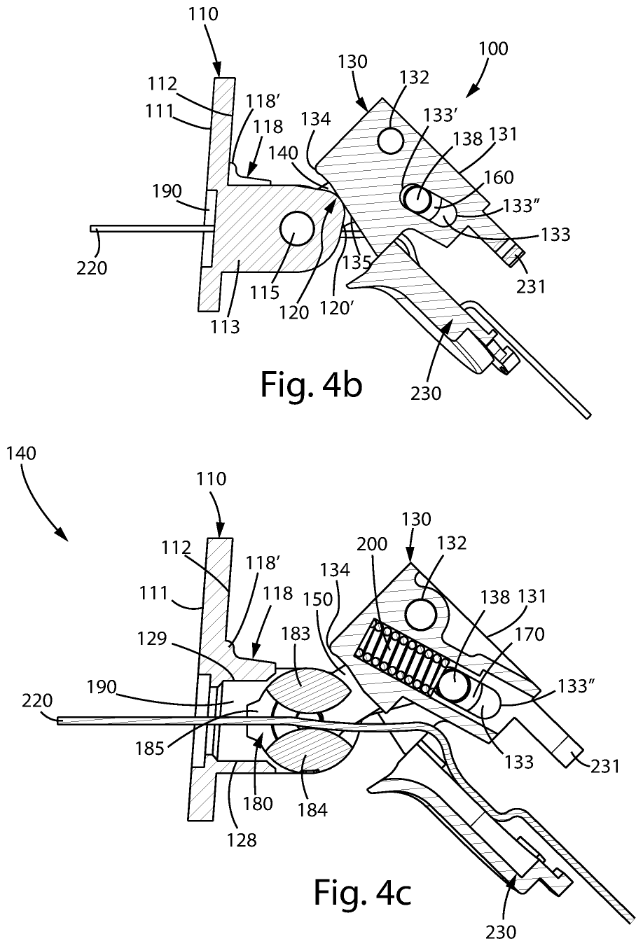

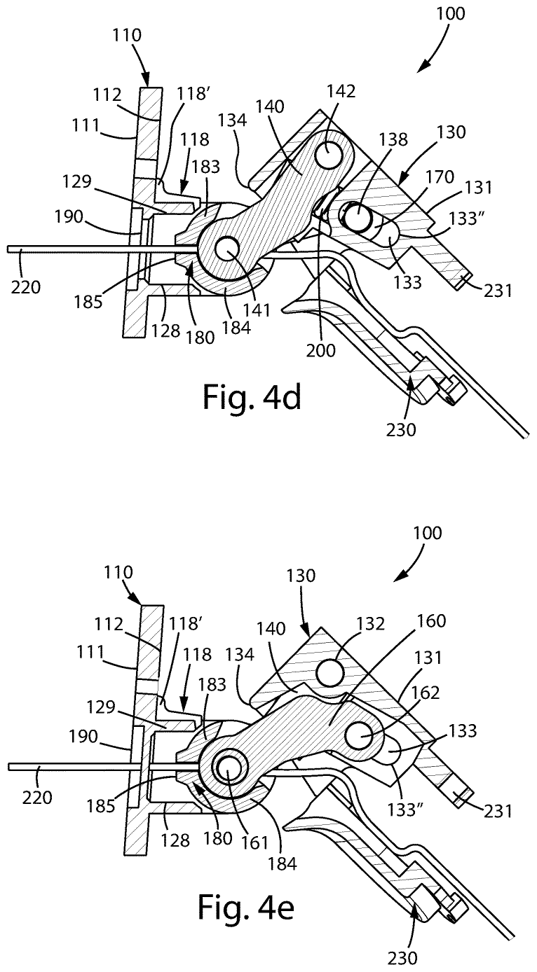

FIGS. 4a, 4b, 4c, 4d, 4e are five sectional views respectively along lines IVa-IVa, IVb-IVb, IVc-IVc, IVd-IVd, IVe-IVe of the hinge assembly for glasses of FIG. 3c;

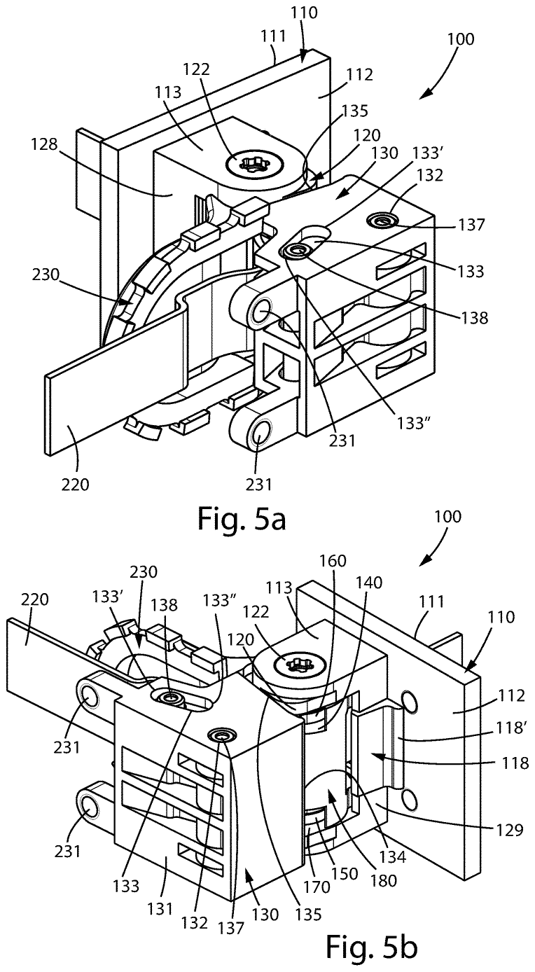

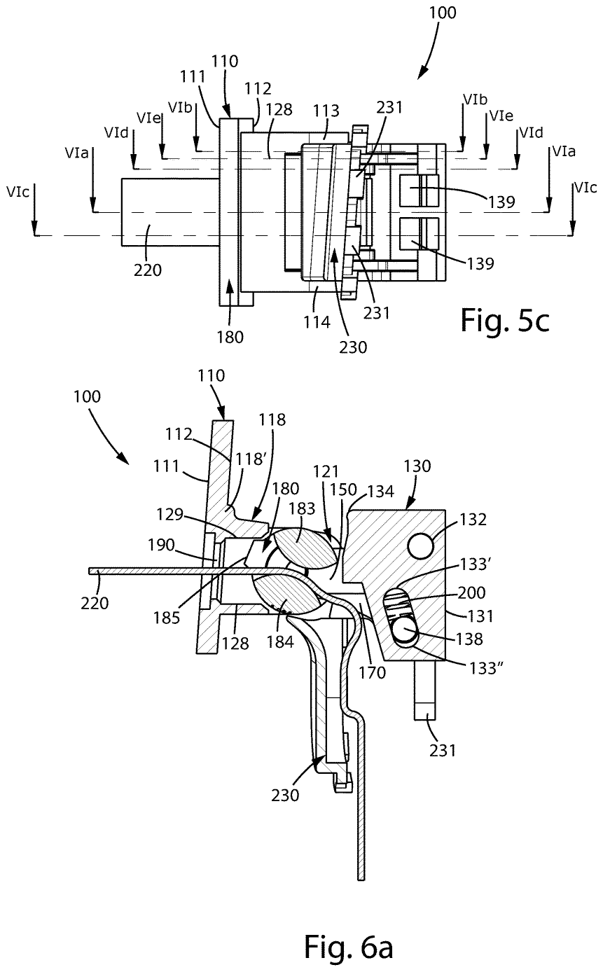

FIG. 5a is a fifth perspective view of the hinge assembly for glasses according to the first embodiment of the present invention when it is in the second stable closing position;

FIG. 5b is a sixth perspective view of the hinge assembly for glasses of FIG. 5a;

FIG. 5c is a third frontal view, taken from the space interposed between the temple and the front, of the hinge assembly for glasses of FIG. 5a;

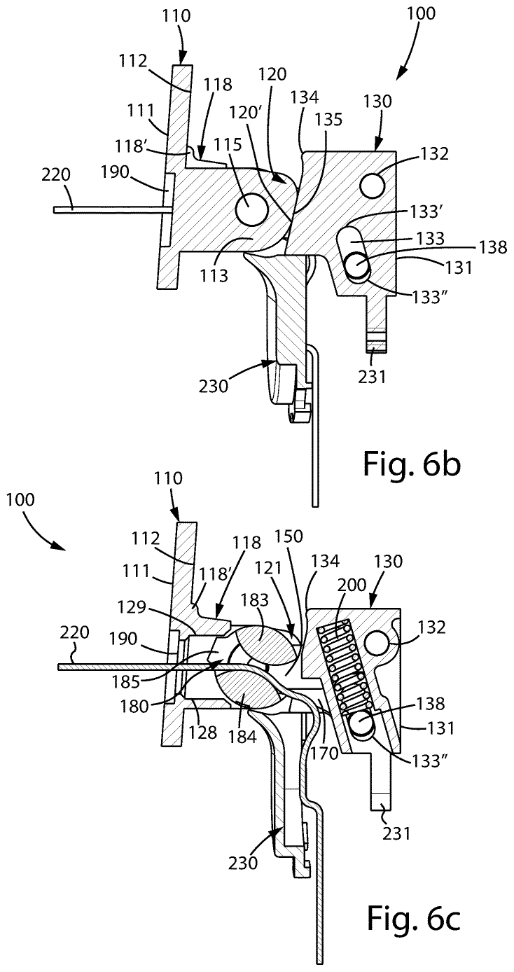

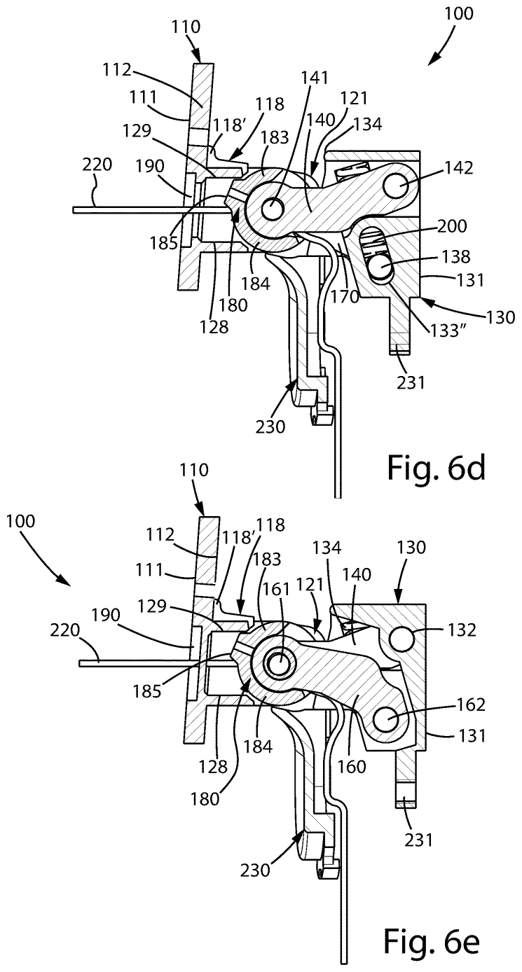

FIGS. 6a, 6b, 6c, 6d, 6e are five sectional views respectively along lines VIa-VIa, VIb-VIb, VIc-VIc, VId-VId, VIe-VIe of the hinge assembly for glasses of FIG. 5c;

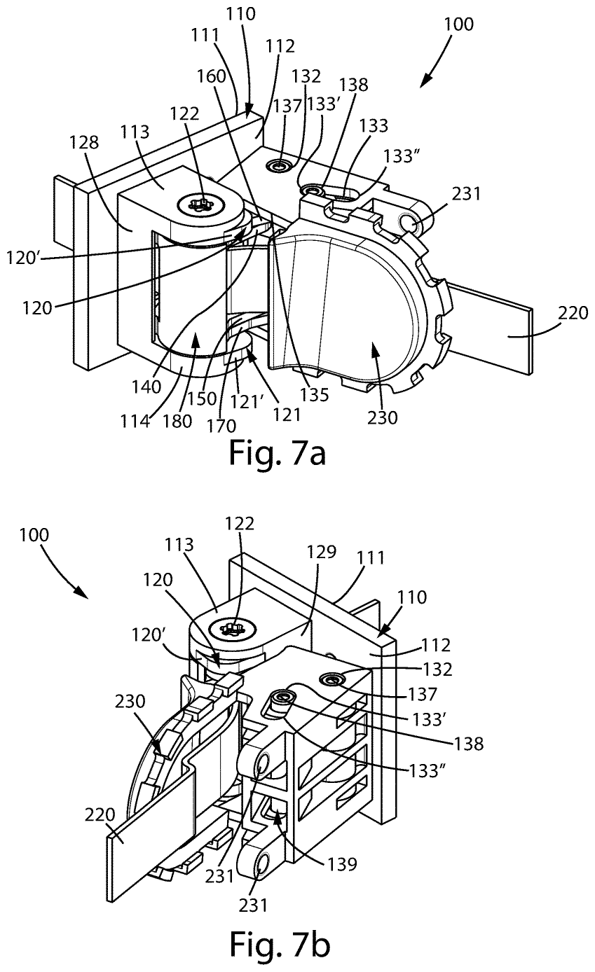

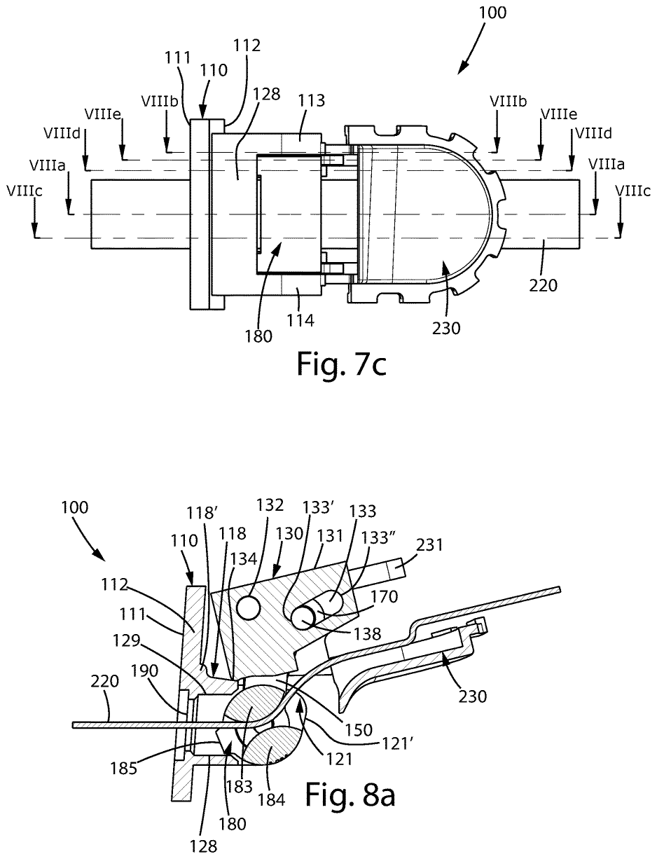

FIG. 7a is a seventh perspective view of the hinge assembly for glasses according to the first embodiment of the present invention when it is in a third unstable extra-opening position;

FIG. 7b is an eighth perspective view of the hinge assembly for glasses of FIG. 7a;

FIG. 7c is a fourth frontal view, taken from the space interposed between the temple and the front, of the hinge assembly for glasses of FIG. 7a;

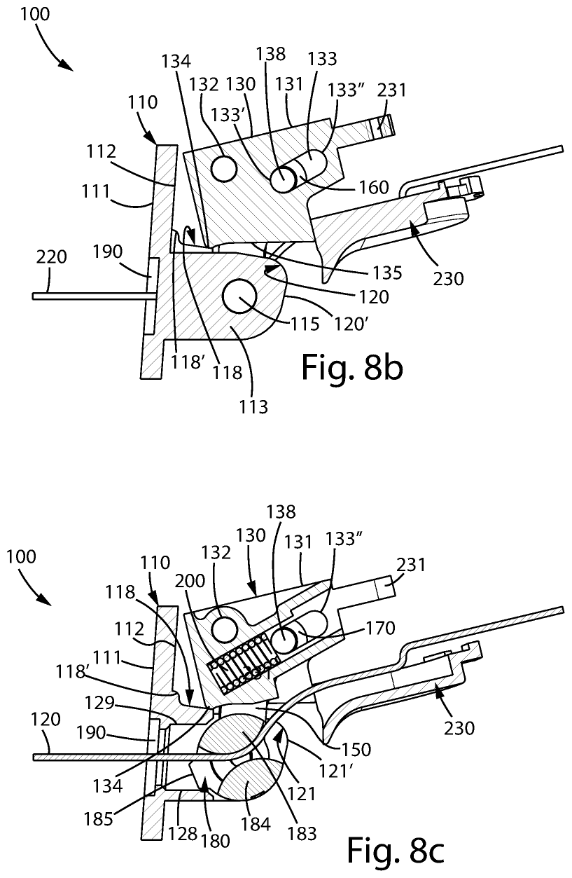

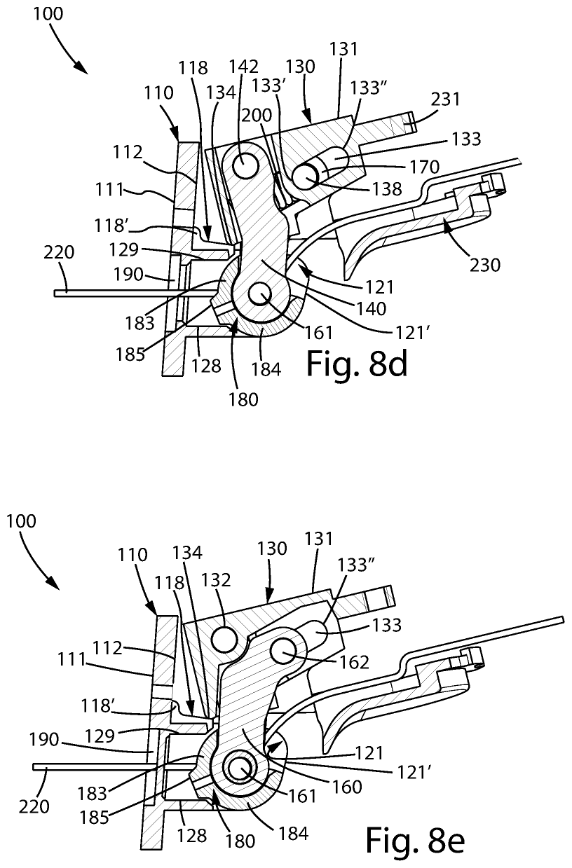

FIGS. 8a, 8b, 8c, 8d, 8e are five sectional views respectively along lines VIIIa-VIIIa, VIIIb-VIIIb, VIIIc-VIIIc, VIIId-VIIId, VIIIe-VIIIe of the hinge assembly for glasses of FIG. 7c;

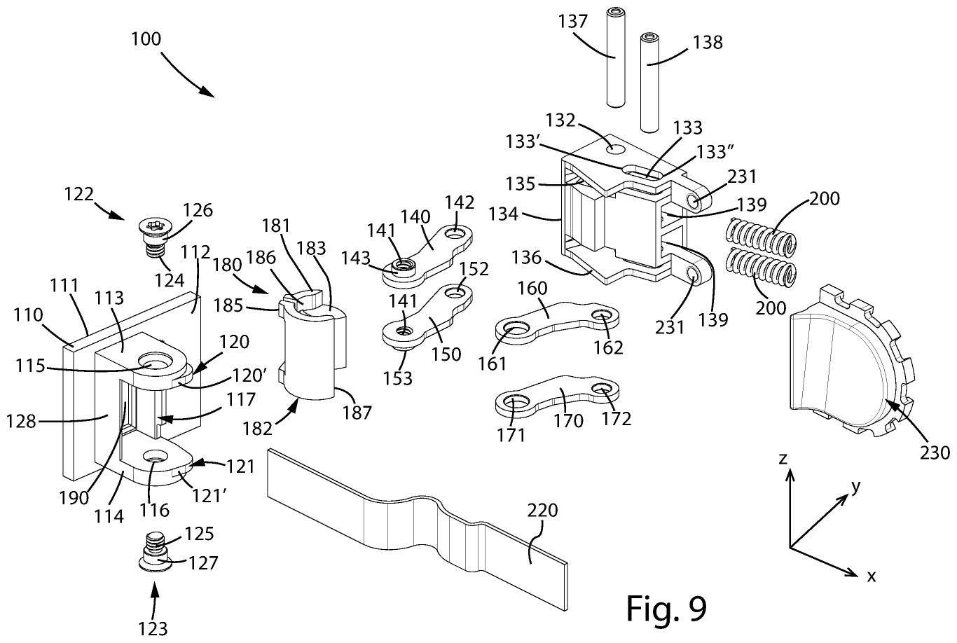

FIG. 9 is a ninth perspective view of the hinge assembly for glasses in an exploded view according to the first embodiment of the present invention;

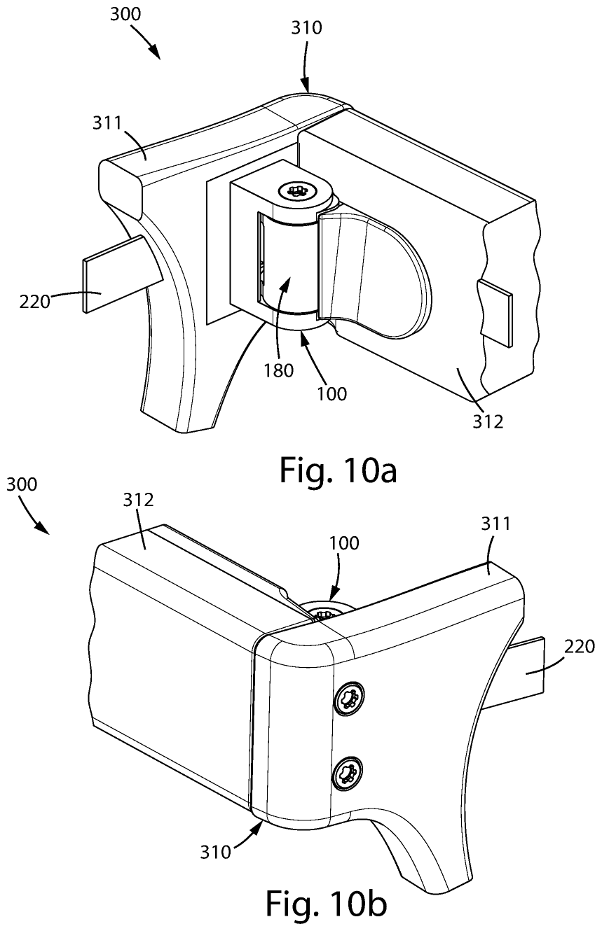

FIGS. 10a and 10b are two partial perspective schematic views of glasses comprising the hinge assembly for glasses according to the first embodiment of the present invention;

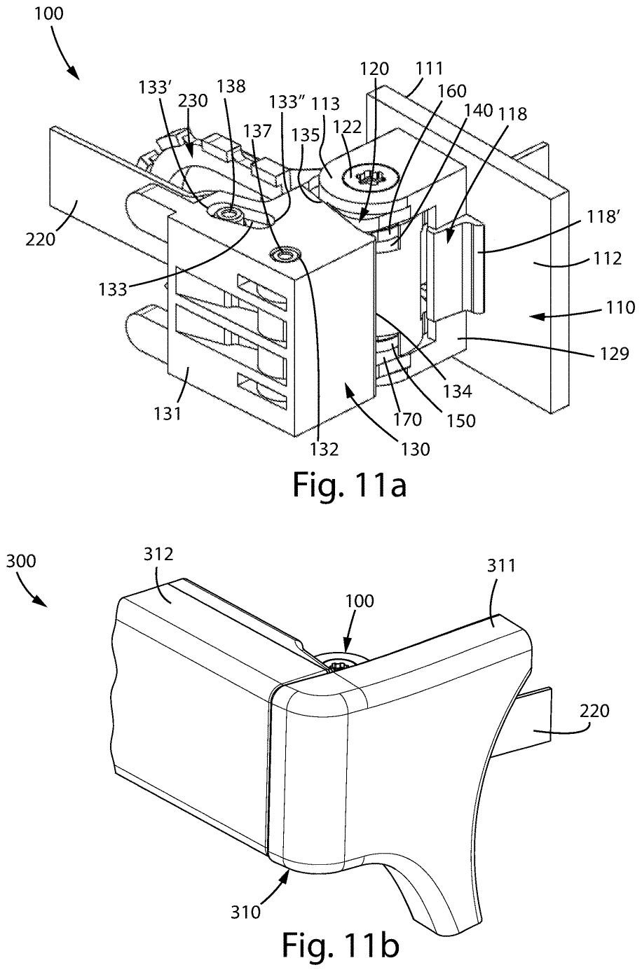

FIG. 11a is a perspective view of a hinge assembly for glasses according to a second embodiment of the present invention;

FIG. 11b is a partial perspective schematic view of glasses comprising the hinge assembly of FIG. 11a;

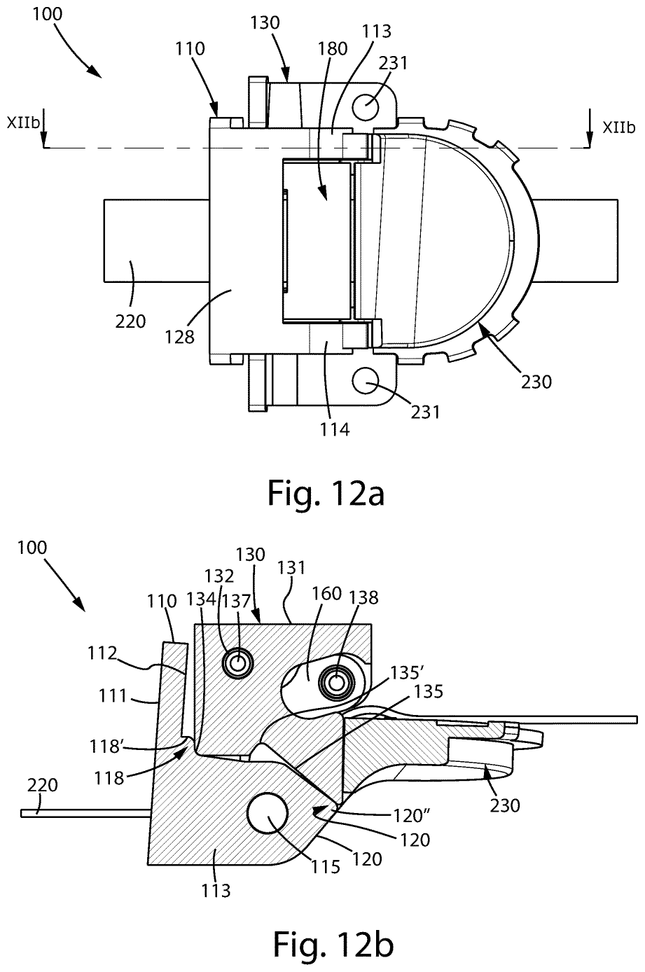

FIG. 12a is a frontal view, taken from the space interposed between the temple and the front, of a hinge assembly for glasses according to a third embodiment of the present invention when it is in the first stable opening position;

FIG. 12b is a sectional view along line XIIb-XIIb of the hinge assembly for glasses of FIG. 12a;

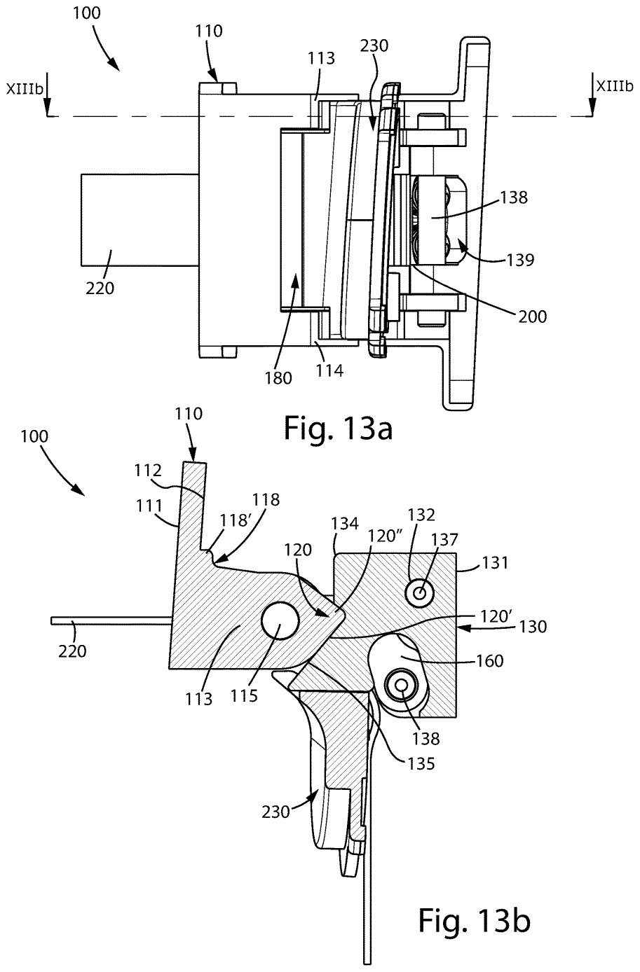

FIG. 13a is a frontal view, taken from the space interposed between the temple and the front, of the hinge assembly for glasses according to the third embodiment of the present invention when it is in the second stable opening position;

FIG. 13b is a sectional view along line XIIIb-XIIIb of the hinge assembly for glasses of FIG. 13a;

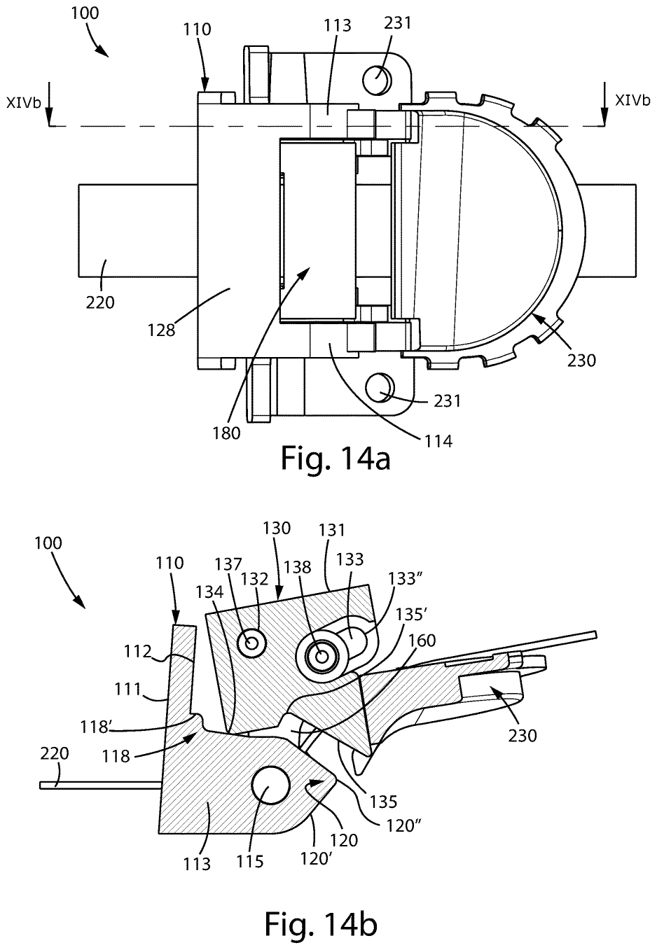

FIG. 14a is a frontal view, taken from the space interposed between the temple and the front, of the hinge assembly for glasses according to the third embodiment of the present invention when it is in the third unstable extra-opening position;

FIG. 14b is a sectional view along line XIVb-XIVb of the hinge assembly for glasses of FIG. 13a;

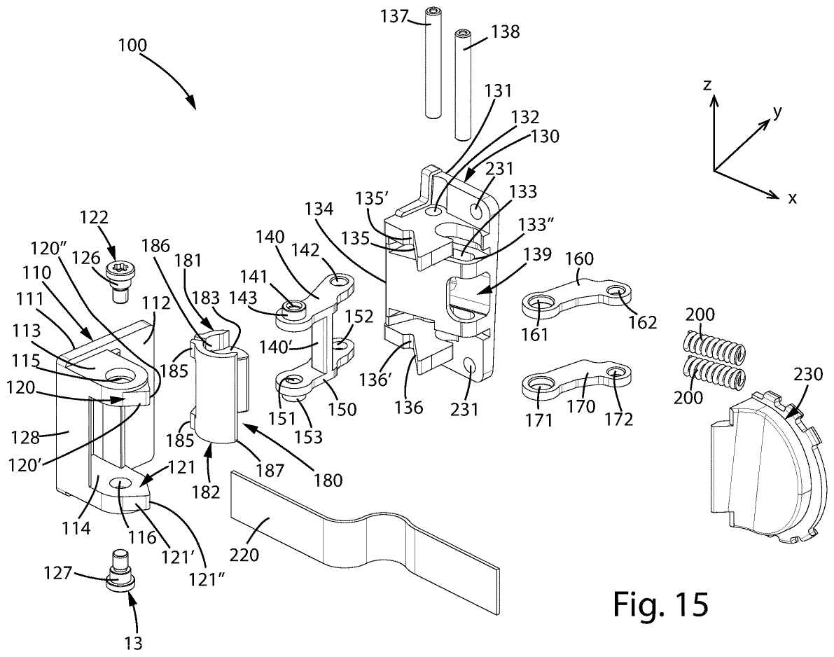

FIG. 15 is a perspective view of the hinge assembly for glasses in an exploded view according to the third embodiment of the present invention;

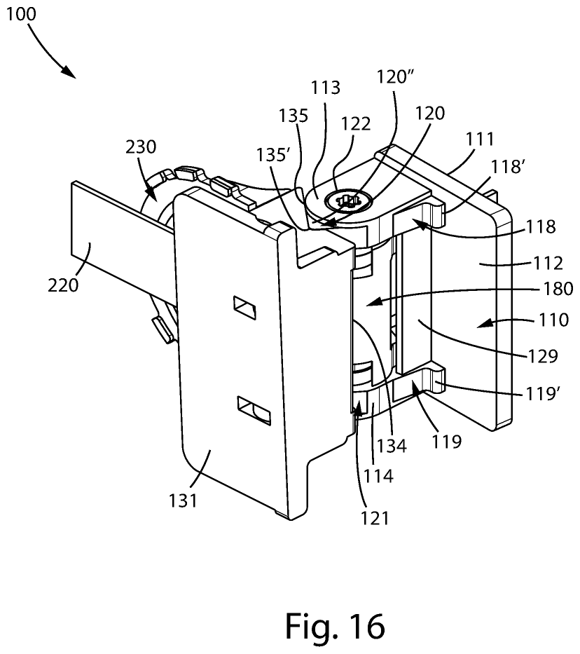

FIG. 16 is a perspective view of the hinge assembly for glasses according to a fourth embodiment of the present invention.

With reference to the attached figures, a hinge assembly for glasses overall indicated by 100 is shown.

The hinge assembly for glasses 100 can be advantageously mounted in a pair of glasses 300. Such glasses 300 comprise a frame 310 comprising in turn a front 311 adapted to carry two lenses and two temples 312 adapted to allow a user to wear the glasses 300, two hinge assemblies for glasses 100 each of which couples a respective temple 312 to the front 311.

In a particular embodiment, the glasses 300 are of the “smart” type. In such a case, the glasses 300 also comprise an electric cable 220, preferably flexible, adapted to electrically connect to each other electric and/or electronic devices installed in the front 311 and in the temples 312.

In the present description, reference will be made for ease and clarity of discussion to a Cartesian axes system xyz represented in the figures comprising a transverse axis x, a longitudinal axis y and a vertical axis z and to an orientation of the hinge assembly for glasses 100 as that illustrated in FIG. 9 and in FIG. 15.

The hinge assembly for glasses 100 comprises a support plate 110 provided with a first face 111 substantially flat and a second face 112 substantially flat opposite and parallel to the first. Particularly, the first face 111 is intended to be applied to a front 311 of the frame 310. Furthermore, the support plate 110 comprises a first cantilevered portion 113 and a second cantilevered portion 114 parallel and opposite to each other extending from the second face 112 in a direction substantially perpendicular to it, i.e., a direction substantially parallel to the transverse axis x. In more detail, the cantilevered portions 113, 114 present a first through hole 115 and a second through hole 116 opposite and aligned with each other along a direction substantially parallel to the vertical axis z.

The two cantilevered portions 113, 114 identify a free space therebetween that makes a receiving seat 117.

The hinge assembly for glasses 100 also comprises a support body 130 intended to be applied to the temple 312. Particularly, the support body 130 presents a box shape and a first face 131 substantially flat intended to be fixed to the temple 312.

Advantageously, the support body 130 is rotatably coupled to the support plate 110 such that the hinge assembly for glasses 100 is capable of assuming a first stable opening position, corresponding to the position in which the temples 312 of the glasses 300 are open and the glasses 300 can be worn, a second stable closing position corresponding to the position in which the temples 312 of the glasses 300 are closed and the glasses 300 cannot be worn, and a third unstable extra-opening position in which the temples 312 are open in addition to the first stable opening position.

The support body 130 comprises a third through hole 132 and a slotted through hole 133. The third through hole 132 and the slotted through hole 133 have axes parallel to each other and substantially parallel to the vertical axis z.

Advantageously, the support body 130 and the support plate 110 comprise respective interaction elements 118, 119, 120, 121, 134, 135, 136 adapted to guide the reciprocal rotation of the support body 130 and the support plate 110 between the first stable opening position and the second stable closing position and between the first stable opening position and the third unstable extra-opening position.

The interaction elements 118, 119, 120, 121, 134, 135, 136 comprise at least one guide element 118, 119 interposed between the first cantilevered portion 113 and the second cantilevered portion 114. Furthermore, the at least one guide element 118, 119 presents a respective endstroke abutment portion 118′, 119′.

The interaction elements 118, 119, 120, 121, 134, 135, 136 also comprise a guide end 134 of the support body 130. The guide end 134 is shaped to slide on the at least one guide element 118, 119 in order to guide the reciprocal rotation of the support body 130 and the support plate 110 between the first stable opening position and the third unstable extra-opening position. Furthermore, the guide end 134 is configured to be in contact with the endstroke abutment portion 118′, 119′ when the hinge assembly for glasses 100 is in the first stable opening position.

Preferably, the at least one guide element 118, 119 is made in a single piece with the support plate 110. In such a case, the at least one guide element 118, 119 can protrude from the second face 112 of the support plate 110.

Alternatively, the at least one guide element 118, 119 is coupled to the support plate 110, particularly to the second face 112 of the support plate 110.

In the third and the fourth embodiments illustrated in FIGS. 12a-15 and 16, respectively, the guide elements 118, 119 are in number equal to two, each one arranged at a respective cantilevered portion 113, 114.

The interaction elements 118, 119, 120, 121, 134, 135, 136 also comprise a first guide projection or first cam 120 and a second guide projection or second cam 121 made on the first cantilevered portion 113 and on the second cantilevered £ portion 114, respectively.

The first guide projection or first cam 120 and the second guide projection or second cam 121 are parallel and opposite to each other.

The interaction elements 118, 119, 120, 121, 134, 135, 136 also comprise at least one free abutment wall 135, 136 of the support body 130 configured to slide on the first cam 120 and the second cam 121 in order to guide the reciprocal rotation of the support body 130 and the support plate 110 between the first stable opening position and the second stable closing position.

In the illustrated embodiments, the free abutment walls 135, 136 are in number equal to two; in such a case, the free abutment walls 135, 136 correspond to side walls of two free edges of the support body 130 facing the first cantilevered portion 113 and the second cantilevered portion 114, respectively.

In the case where there is a single free abutment wall 135, 136 the support body 130 presents a single wall facing the first cantilevered portion 113 and the second cantilevered portion 114.

In more detail, when the hinge assembly for glasses 100 is in the first stable opening position, the guide end 134 is in contact c and in abutment with the endstroke abutment portion 118′, 119′.

When the hinge assembly for glasses 100 passes from the first stable opening position to the third unstable extra-opening position, the guide end 134 slides along the at least one guide element 118, 119 detaching and moving away from the endstroke abutment portion 118′, 119′.

When the hinge assembly for glasses 100 passes from the first stable opening position to the second stable closing position, the at least one free abutment wall 135, 136 slides along the first guide projection 120 and the second guide projection 121; during such a passage, the support body 130 makes a first rotary movement around the axis passing through the first through hole 115 and the second through hole 116 of the cantilevered portions 113, 114 of the support plate 110 quantifiable with a determined first angular excursion.

Vice versa, when the hinge assembly for glasses 100 passes from the second stable closing position to the first stable opening position, the at least one free abutment wall 135, 136 slides, as in the preceding case, along the first guide projection 120 and the second guide projection 121; during such a passage, the support body 130 makes a second rotary movement around the axis passing through the first through hole 115 and the second through hole 116 of the cantilevered portions 113, 114 of the support plate 110 in a direction opposite to that previously described and quantifiable with a determined second angular excursion equal and opposite to the first angular excursion of the first rotary movement.

The hinge assembly for glasses 100 also comprises a first arm element 140 and a second arm element 150.

The first arm element 140 and the second arm element 150 respectively have first perforated end portions 141, 151 and second perforated end portions 142, 152.

The first perforated end portion 141 of the first arm element 140 is arranged at the first through hole 115 of the first cantilevered portion 113. The first perforated end portion 151 of the second arm element 150 is arranged at the second through hole 116 of the second cantilevered portion 114.

In the third and the fourth embodiments respectively illustrated in FIGS. 12a-15 and 16, the first arm element 140 and the second arm element 150 are connected by a connection element 140′.

The connection element 140′ can be made in a single piece with the first arm element 140 and the second arm element 150.

The hinge assembly for glasses 100 also comprises a first coupling element 122 and a second coupling element 123 that cross at least partially respectively the first through hole 115 and the second through hole 116 of the cantilevered portions 113, 114 of the support plate 110 and are coupled with the first perforated end portions 141, 151 of the first arm element 140 and the second arm element 150.

Preferably, the first perforated end portions 141, 151 present threaded holes. In such a case, the first coupling element 122 and the second coupling element 123 present corresponding threaded ends 124, 125 adapted to couple with the threaded holes of the first perforated end portions 141, 151.

The first coupling element 122 and the second coupling element 123 further present respective cylindrical portions 126, 127 adapted to allow the rotation of the coupling elements 122, 123 within the first through hole 115 and the second through hole 116.

The first coupling element 122 and the second coupling element 123 are for example made in the form of a screw having the terminal portion of the stem being threaded and an intermediate cylindrical portion being unthreaded.

Alternatively, the first perforated end portions 141, 151 do not present threaded holes. In such a case, the first coupling element 122 and the second coupling element 123 do not present the corresponding threaded ends 124, 125 and are coupled with interference with the first perforated end portions 141, 151.

The second perforated end portions 142, 152 of the first arm element 140 and the second arm element 150 are instead housed in the support body 130 such as to be coaxial with respect to the third through hole 132.

The hinge assembly for glasses 100 further comprises at least one first coupling pin 137 housed in the third through hole 132 of the support body 130 and that crosses the second perforated end portions 142, 152 of the first arm element 140 and the second arm element 150.

The second perforated end portions 142, 152 are free to rotate with respect to the at least one first coupling pin 137.

In the illustrated embodiments, the hinge assembly for glasses 100 can comprise a first coupling pin 137 that entirely crosses the third through hole 132.

Alternatively, the hinge assembly for glasses 100 can comprise two first coupling pins 137 and each of the second perforated end portions 142, 152 is crossed by one of such first coupling pins 137, respectively. In such a case, the second perforated end portion 142 of the first arm element 140 is crossed by one of the two first coupling pins 137 while the second perforated end portion 152 of the second arm element 150 is crossed by the other of the two first coupling pins 137.

The hinge assembly for glasses 100 also comprises a third arm element 160 and a fourth arm element 170. The third arm element 160 and the fourth arm element 170 respectively present third perforated end portions 161, 171 and fourth perforated end portions 162, 172.

The third perforated end portions 161, 171 are rotatably coupled to the first perforated end portions 141, 151 of the first arm element 140 and the second arm element 150, respectively.

Preferably, the first perforated end portions 141, 151 present around their own holes cylindrical delimitation walls 143, 153 that protrude for a length section beyond the surface of such portions toward the first cantilevered portion 113 and the second cantilevered portion 114, respectively; in such a case, the third perforated end portions 161, 171 are placed on the first perforated end portions 141, 151 such that the respective holes are coaxial and the cylindrical delimitation walls 143, 153 penetrate in the respective holes of the third perforated end portions 161, 171. In this manner, the third arm element 160 is free to rotate with respect to the first arm element 140 around the axis of the holes of the first perforated end portion 141 of the first arm element 140 and the third perforated end portion 161 of the third arm element 160; similarly, the fourth arm element 170 is free to rotate with respect to the second arm element 150 around the axis of the holes of the first perforated end portion 151 of the second arm element 150 and the third perforated end portion 171 of the fourth arm element 170.

The fourth perforated end portions 162, 172 of the third arm element 160 and the fourth arm element 170 are housed in the support body 130 at the slotted through hole 133.

Furthermore, the hinge assembly for glasses 100 comprises a second coupling pin 138 that crosses the slotted through hole 133 of the support body 130 and the fourth perforated end portions 162, 172 respectively of the third arm element 160 and the fourth arm element 170. The fourth perforated end portions 162, 172 are free to rotate with respect to the second coupling pin 138.

The at least one first coupling pin 137 allows the rotation of the support body 130, while the second coupling pin 138 controls the translation and thus the opening of the temple 312 in the third unstable extra-opening position.

The support body 130 further comprises at least one housing chamber 139 open toward the outside and in communication with the slotted through hole 133.

Preferably, the at least one housing chamber 139 can be more than one. For example, in the first and the second embodiments illustrated in FIGS. 1a-10b and 11a-11b, respectively, the support body 130 comprises two of said housing chambers 139, parallel to each other and arranged in succession along the vertical axis z.

The hinge assembly for glasses 100 also comprises at least one elastic element 200 housed in the at least one housing chamber 139. In more detail, the at least one elastic element 200 is in contact with a bottom wall of the at least one housing chamber 139 on one side and in contact with the second coupling pin 138 on the other side.

Preferably, the at least one elastic element 200 can be more than one and particularly can be in number equal to the number of the housing chambers 139. For example, in the first and the second embodiments illustrated in FIGS. 1a-10b and 11a-11b, respectively, the elastic elements 200 are two springs, each housed in the respective housing chamber 139.

Instead, in the third and the fourth embodiments illustrated in FIGS. 12a-15 and 16, respectively, the at least one housing chamber 139 is one, while the elastic elements 200 are two.

When the hinge assembly for glasses 100 is in the first stable opening position, a passage can be made to the third unstable extra-opening position, pushing in rotation the support body 130 in a direction opposite to what would be done to reach the second stable closing position. Forcing the rotation of the support body 130, the support body 130 is forced to rotate around an axis passing through the third through hole 132 and no longer the axis passing through the first through hole 115 and the second through hole 116. In such a case, the guide end 134 remains in contact with the at least one guide element 118, 119.

Still in the passage from the first stable opening position the third unstable extra-opening position, the second coupling pin 138 slides in the slotted through hole 133 to a first endstroke end 133′ that defines the third unstable extra-opening position. In this manner, the second coupling pin 138 compresses the at least one elastic element 200 housed in the at least one housing chamber 139; thus, once released the support body 130, the hinge assembly for glasses 100 returns from the third unstable extra-opening position to the first stable opening position due to the elastic return force of the at least one elastic element 200 that, by elongating, pushes the second coupling pin 138 sliding the latter in the slotted through hole 133 toward a second endstroke end 133″ opposite to the first 133′.

Preferably, the first guide projection 120 and the second guide projection 121 present a first flat abutment portion 120′ and a second flat abutment portion 121′, respectively, on which the at least one free abutment wall 135, 136 abuts and stops by identifying the second stable closing position.

In more detail, during the passage from the first stable opening position to the second stable closing position, the support body 130 can keep rotating until the at least one free abutment wall 135, 136 abuts on the first flat abutment portion 120′ and the second flat abutment portion 121′; at this point, the second stable closing position is identified and the support body 130 cannot keep rotating.

In the third and the fourth embodiments illustrated in FIGS. 12a-15 and 16, respectively, the at least one free abutment wall 135, 136 presents a first perimetric recess 135′ and a second perimetric recess 136′ facing the first cantilevered portion 113 and the second cantilevered portion 114, respectively. In such a case, the first guide projection or first cam 120 presents a first abutting protrusion 120″ and the second guide projection or second cam 121 presents a second abutting protrusion 121″.

The first abutting protrusion 120″ and the second abutting protrusion 121″ are shaped to fit in the first perimetric recess 135′ and the second perimetric recess 136′, respectively, when the hinge assembly for glasses 100 is in the second stable closing position.

The first abutting protrusion 120″ and the first perimetric recess 135′ have a shape complementary to each other.

The second abutting protrusion 121″ and the second perimetric recess 136′ have a shape complementary to each other.

In the case where the at least one free abutment wall 135, 136 are two, furthermore, the first perimetric recess 135′ and the second perimetric recess 136′ are arranged on the side walls of the two free edges of the support body 130.

In more detail, when the at least one free abutment wall 135, 136 abuts on the first flat abutment portion 120′ and the second flat abutment portion 121′, the first abutting protrusion 120″ fits in the first perimetric recess 135′ and the second abutting protrusion 121″ fits in the second perimetric recess 136′.

Furthermore, the hinge assembly for glasses 100 comprises a cover element 230 integral with the support body 130. The cover element 230 can be coupled to the support body 130 or made in a single piece with such support body 130.

Preferably, the cover element 230 is configured to abut on the first cantilevered portion 113 and the second cantilevered portion 114 when the hinge assembly for glasses 100 is in the second stable closing position.

In more detail, during the passage from the first stable opening position to the second stable closing position, the support body 130 can keep rotating until the cover element 230 abuts on the first cantilevered portion 113 and the second cantilevered portion 114; at this point, the second stable closing position is identified and the support body 130 cannot keep rotating.

In the particular embodiment in which the glasses 300 are of the “smart” type, the hinge assembly for glasses 100 also comprises a masking and guide body 180 for the electric cable 220 extending along the axis z between a first end 181 and a second end 182. Such a masking and guide body 180 for the electric cable 220 is interposed between the two cantilevered portions 113, 114 in the receiving seat 117 such that the first end 181 faces the first cantilevered portion 113 and the second end 182 faces the second cantilevered portion 114.

In such a case, the first perforated end portion 141 of the first arm element 140 is interposed between the first end 181 of the masking and guide body 180 for the electric cable 220 and the first cantilevered portion 113. The first perforated end portion 151 of the second arm element 150 is interposed between the second end 182 of the masking and guide body 180 for the electric cable 220 and the second cantilevered portion 114.

Preferably, the masking and guide body 180 for the electric cable 220 comprises a first resting portion 183 and a second resting portion 184 spaced apart from each other extending in length between the first end 181 and the second end 182, and at least one bridge element 185 that connects such resting portions 183, 184 to each other. Therefore, the two resting portions 183, 184 face each other and define a free interspace therebetween.

Preferably, the resting portions 183, 184 present two perimetric abutment walls 186, 187 protruding along a direction substantially parallel to the vertical axis z beyond the first end 181 and the second end 182 making two housing seats for the first perforated end portions 141, 151.

The masking and guide body 180 for the electric cable 220 cannot escape from the receiving seat 117 as in the vertical direction z its movement is limited by the presence of the first perforated end portions 141, 151 and the third perforated end portions 161, 171, in the transverse plane xy its movement is limited by the interference between the perimetric abutment walls 186, 187 and the respective first perforated end portions 141, 151 and third perforated end portions 161, 171.

The masking and guide body 180 for the electric cable 220 is instead free to rotate around the axis passing through the first through hole 115 and the second through hole 116.

Preferably, the support plate 110 comprises a first side wall 128 and a second side wall 129 that connect the first cantilevered portion 113 to the second cantilevered portion 114. In such a case, the at least one guide element 118, 119 can be made in a single piece with the second side wall 129.

Preferably, the support plate 110 also comprises an opening 190 positioned along the vertical direction z between the first cantilevered portion 113 and the second cantilevered portion 114 and along the longitudinal direction y between the two side walls 128, 129.

In the first and the third embodiments respectively illustrated in FIGS. 1a-10b and 12a-15, the support body 130 comprises at least one anchoring portion 231 adapted to be fixed on the temple 312 of the glasses 300. In detail, the temple 312 is interposed between the at least one anchoring portion 231 of the support body 130 and the cover element 230.

Instead, in the second and the fourth embodiments illustrated in FIGS. 11a and 16, respectively, the support body 130 is appliable to the temple 312 of the glasses 300 for example by gluing or overmoulding and, similarly, the support plate 110 is appliable to the front 311 of the glasses 300 for example by gluing or overmoulding.

Preferably, the electric cable 220 coming from the front 311 of the glasses 300 crosses the opening 190 of the support plate 110 and the interspace between the resting portions 183, 184 engaging to engaging portions (not illustrated) of the cover element 230.

When the hinge assembly for glasses 100 is in the first stable opening position, the at least one bridge element 185 of the masking and guide body 180 for the electric cable 220 is in contact with and abuts on the first side wall 128 of the support plate 110; furthermore, the electric cable 220 is in contact with and abuts on a surface of the first resting portion 183 of the masking and guide body 180 for the electric cable 220.

When the hinge assembly for glasses 100 is in the second stable closing position, the at least one bridge element 185 of the masking and guide body 180 for the electric cable 220 is in contact with and abuts on the second side wall 129 of the support plate 110; furthermore, the electric cable 220 is in contact with and abuts on a surface of the second resting portion 184 of the masking and guide body 180 for the electric cable 220.

When the hinge assembly for glasses 100 passes from the first stable opening position to the second stable closing position, the electric cable 220 is dragged in rotation by the cover element 230 that causes it to detach from the first resting portion 183 until contacting the second resting portion 184. At this point, the electric cable 220 drags in rotation the masking and guide body 180 for the electric cable 220, the at least one bridge element 185 is detached from the first side wall 128 and rotates together with the masking and guide body 180 for the electric cable 220 toward the second side wall 129 of the support plate 110. During an initial step of the rotation of the support body 130 the masking and guide body 180 for the electric cable 220 does not rotate until the electric cable 220 abuts on the second resting portion 184. The masking and guide body 180 for the electric cable 220, therefore, rotates with a first angular delay with respect to the support body 130.

During a terminal step of the rotation of the support body 130 the masking and guide body 180 for the electric cable 220 does not rotate as the at least one bridge element 185 abuts on the second side wall 129. The support body 130 keeps rotating until the at least one free abutment wall 135, 136 abuts and stops on the first flat abutment portion 120′ and the second flat abutment portion 121′ and/or the cover element 230 abuts on the first cantilevered portion 113 and the second cantilevered portion 114 determining a second angular delay of the masking and guide body 180 for the electric cable 220 with respect to the support body 130.

Preferably, the first angular delay is between 1° and 45°.

Preferably, the second angular delay is between 1° and 45°.

Preferably, the first angular delay is substantially equal to the second angular delay.

In the passage from the first stable opening position to the second stable closing position the electric cable 220 is not subjected to the first angular excursion, but to a third angular excursion obtained by subtracting the first angular delay and the second angular delay from the first angular excursion.

Preferably, as observable in figures, the third angular excursion is 45 degrees.

When the hinge assembly for glasses 100 passes from the second stable closing position to the first stable opening position, the electric cable 220 is dragged in rotation by the cover element 230 that causes it to detach from the second resting portion 184 until contacting the first resting portion 183. At this point, the electric cable 220 drags in rotation the masking and guide body 180 for the electric cable 220, the at least one bridge element 185 is detached from the second side wall 129 and rotates together with the masking and guide body 180 for the electric cable 220 toward the first side wall 128 of the support plate 110.

During an initial step of the rotation of the support body 130 the masking and guide body 180 for the electric cable 220, therefore, rotates with the second angular delay with respect to the support body 130. During a terminal step of the rotation of the support body 130 the masking and guide body 180 for the electric cable 220 does not rotate as the at least one bridge element 185 abuts on the first side wall 128 but the support body 130 keeps rotating until the guide end 134 reaches the endstroke abutment portion 118′, 119′ determining the first angular delay of the masking and guide body 180 for the electric cable 220 with respect to the support body 130.

Therefore, the distance between the side walls 128, 129 is such as to determine the first angular delay between the rotation of the support body 130 and the rotation of the masking and guide body 180 for the electric cable 220 and the second angular delay between the rotation of the support body 130 and the rotation of the masking and guide body 180 for the electric cable 220.

The features of the hinge assembly for glasses being the object of the present invention are clear from the performed description, as well as the related advantages are clear.

Indeed, the hinge assembly for glasses according to the present invention is bistable and at the same time is flexible and allows to preserve the integrity of the hinge itself during the passage of the temple from the opening position to the extra-opening position or vice versa, as well as to prevent the wear of the temple and the front due to the interaction elements.

Finally, t is clear that the hinge assembly for glasses and the glasses thus conceived are susceptible of a number of modifications and variants, all falling within the invention; furthermore, all the details are replaceable by technically equivalent elements. In practice, the used materials, as well as the size, can be any depending on the technical requirements.

1. A hinge assembly for glasses comprising:
a support plate having a first face substantially flat intended to be applied to a front of a frame for glasses, and a second face substantially flat opposite and parallel to said first face, said support plate comprising a first cantilevered portion and a second cantilevered portion parallel and opposite to each other extending from said second face in a direction substantially perpendicular to it, said cantilevered portions respectively presenting a first through hole and a second through hole opposite and aligned with each other along a vertical direction z;
a support body intended to be applied to a temple for glasses, said support body being rotatably coupled to said support plate, said support body and said support plate comprising respective interaction elements adapted to guide the reciprocal rotation of said support body and said support plate between a first stable opening position of said hinge assembly for glasses and a second stable closing position of said hinge assembly for glasses and between said first stable opening position of said hinge assembly for glasses and a third unstable extra-opening position of said hinge assembly for glasses,
wherein said interaction elements comprise:
at least one guide element interposed between said first cantilevered portion and said second cantilevered portion, said at least one guide element presenting a respective endstroke abutment portion;
a guide end of said support body shaped to slide on said at least one guide element in order to guide the reciprocal rotation of said support body and said support plate between said first stable opening position and said third unstable extra-opening position, said guide end being configured to be in contact with said endstroke abutment portion when the hinge assembly for glasses is in the first stable opening position;
a first guide projection or first cam and a second guide projection or second cam made on said first cantilevered portion and on said second cantilevered portion respectively, said first guide projection or first cam and said second guide projection or second cam being parallel and opposite to each other;
at least one free abutment wall of said support body configured to slide on said first cam and said second cam in order to guide the reciprocal rotation of said support body and said support plate between said first stable opening position and said second stable closing position.

2. The hinge assembly for glasses, according to claim 1, wherein said first guide projection and said second guide projection present a first flat abutment portion and a second flat abutment portion, respectively, on which said at least one free abutment wall abuts and stops by identifying the second stable closing position.

3. The hinge assembly for glasses according to claim 1, wherein said at least one free abutment wall presents a first perimetric recess and a second perimetric recess facing said first cantilevered portion and said second cantilevered portion respectively, said first guide projection presenting a first abutting protrusion and said second guide projection presenting a second abutting protrusion, said first abutting protrusion and said second abutting protrusion being shaped to fit in said first perimetric recess and said second perimetric recess, respectively, when the hinge assembly for glasses is in the second stable closing position.

4. The hinge assembly for glasses, according to claim 1, wherein said hinge assembly for glasses comprises a cover element integral with said support body, said cover element being configured to abut on said first cantilevered portion and said second cantilevered portion when said hinge assembly for glasses is in the second stable closing position.

5. The hinge assembly for glasses according to claim 1, wherein said support body comprising a third through hole and a slotted through hole having axes parallel to each other and substantially parallel to said vertical direction z, said support body comprising at least one housing chamber open toward the outside and in communication with said slotted through hole, said hinge assembly for glasses comprising:
a first arm element and a second arm element having respective first perforated end portions arranged respectively at said first through hole and said second through hole of said cantilevered portions, and respective second perforated end portions housed in said support body at said third through hole, said first arm element and said second arm element being connected by a connection element;
at least one first coupling pin housed in said third through hole and that crosses said second perforated end portions
a first coupling element and a second coupling element crossing at least partially respectively said first through hole and said second through hole and coupling respectively with said first perforated end portions;
a third arm element and a fourth arm element having respective third perforated end portions rotatably coupled respectively to said first perforated end portions and respective fourth perforated end portions housed in said support body at said slotted through hole;
a second coupling pin crossing said slotted through hole and said fourth perforated end portions;
at least one elastic element housed in said at least one housing chamber on one side, in contact with a bottom wall of said at least one housing chamber on the other side, in contact with said second coupling pin, said at least one elastic element being compressed by said second coupling pin when the hinge assembly for glasses passes from said first stable opening position to said third unstable extra-opening position, said at least one elastic element pushing said second coupling pin to return from the third unstable extra-opening position to the first stable opening position.

6. The hinge assembly for glasses according to claim 5 comprising two of said first coupling pins, each of said second perforated end portions being crossed by one of said first coupling pins respectively.

7. The hinge assembly for glasses according to claim 1, wherein said at least one guide element is made in a single piece with said support plate.

8. The hinge assembly for glasses according to claim 7, wherein said support plate comprises a first side wall and a second side wall that connect said first cantilevered portion to said second cantilevered portion and said at least one guide element is made in a single piece with said second side wall.

9. The hinge assembly for glasses according to claim 1, wherein said at least one guide element is coupled with said support plate.

10. The hinge assembly for glasses according to claim 1, wherein said guide elements are in number equal to two, each one arranged at a respective cantilevered portion.

11. The hinge assembly for glasses according to claim 1, wherein said free abutment walls are in number equal to two, where said free abutment walls correspond to lateral walls of two free edges of the support body facing the first cantilevered portion and the second cantilevered portion respectively.

12. Glasses comprising:
a front adapted to carry two lenses and two temples, said temples adapted to allow a user to wear glasses;
two hinge assemblies for glasses according to the present invention, each of which couples a respective temple to said front.
